(19) United States
(12) Patent Application Publication
(10) Pub. No.: US 2019/0307290 A1
(43) Pub. Date: Oct. 10, 2019

(54) Roller Grill Separating Device with Contour Matching Teeth

(71) Applicant: Spirit Specialty Solutions, Inc., Broomall, PA (US)

(72) Inventor: Michael M. Kurmlavage, Broomall, PA (US)

(21) Appl. No.: 15/949,115

(22) Filed: Apr. 10, 2018

(51) Int. Cl. A47J 37/04

(52) U.S. Cl. CPC A47J 37/048

(57) ABSTRACT

Provided is a food separating device for use with a roller grill. The separating device includes a pair of support brackets, a pair of crossover bars, and a plurality of separator bars having a tooth-shaped configuration that extend down and in between the rollers to follow the contour thereof. The support brackets also include vertical members with curved slots for enabling the crossover bars to adjust their height such that the separator bars match the contour of the roller griller rollers with substantially no gap therebetween. The configuration of the separator bars and the curved slots create a divider to separate food located on the roller grill surface, and to prevent food, particularly corn dogs from becoming lodged between or below the rollers. A method of use is also provided.

### BACKGROUND OF THE INVENTION

### 1. Field Of The Invention

The present invention relates to a roller grill separating device. More particularly, it pertains to a roller grill separating device having teeth that extend down and between the roller grill rollers to create a divider that matches the contours of the rollers to prevent food from becoming stuck between or below the rollers.

In this era of fast food, individuals are increasingly dependent on quick service restaurants and convenience stores for a meal. Beginning in the 1960s and increasing in popularity ever since, the roller grill became an efficient way to cook and store hot dogs and other products to be made readily available to consumers without being labor intensive. With the advent of roller grills, these products can be prepared without the necessity of the store clerk flipping or rolling the grilled food by hand throughout the day. The development of the gas station/convenience store made this type of food even more widely available and popular.

With opportunities to sell more products in these numerous establishments, the industry began offering additional types of hot dog products, such as sausage, quarter-pound hot dogs, spicy and mild kielbasa, alternative meat hot dogs, such as turkey, beef or soy, and the like. All of these foods are still best prepared using the roller grill. Presently roller grills are still the leading hot dog cooker of choice for national convenience store chains, vending operations and cafeterias. These roller grills can be used on the front serving counter where customers serve themselves or on a back counter where a store employee takes an order from a customer and assembles and serves the food product.

In a roller grill that can cook many food products at one time, it is not always the case that one type of product is placed on the grill and removed from the grill all at once. Rather, the number of the products on the grill gradually decreases based on sales, and a grill operator accordingly keeps adding uncooked food on the grill. Therefore, cooked products and uncooked products are on the grill at the same time, and it is possible that uncooked products might contaminate cooked products. Without an effective grill separating device, it is hard for a grill operator to organize and manage the grill. It is also hard to identify which food item is cooked and which food item is uncooked, and which item is one type of product and which item is another. Also, hot dog items can move or “walk” from side to side and away from their respective sign identifier, thus confusing customers and operators and making the grill look unorganized.

Additionally, consumers have become increasingly interested in the corn dog, which is a sausage-type meat (usually a hot dog) on a stick that has been coated in a thick layer of cornmeal batter and deep fried. Establishments have shown a desire to offer corn dogs to consumers, however, the conventional configuration of the roller grill is not designed to work with these products. As can be appreciated, corn dogs generally contain a stick that extends from one side, which provides a consumer with a location to grasp onto and eat the product. These sticks, however, become lodged between the roller grill rollers as the corn dog rotates, causing them to be lodged beneath the roller surface and ejected from the cooking surface. At this point, the ejected corn dog is no longer fit for consumption and must be discarded, which increases waste and decreases revenue for establishments.

As can be seen by the foregoing, the main problem inherent in current methods for cooking hot dog products on a roller grill is the need to separate the various types of products and to prevent corn dogs from being inadvertently ejected from the roller grill rollers. It is clear from the above description that a need exists for a roller grill separating device that prevents these problems from occurring.

### 2. Description Of The Prior Art

Various devices have been proposed for overcoming these challenges. For example, in U.S. patent application Ser. No. 12/554,645, the contents of which are hereby incorporated by reference, discloses a roller grill separating device. The device includes a pair of support brackets, a pair of crossover bars, and one or more separator bars. The separator bars in this application, however, do not include teeth that extend down and in between the roller grill rollers to create a divider that matches the contours of the rollers to prevent food from becoming stuck between or below the rollers. Additionally, this device does not include support brackets with vertical members having curved slots for enabling the crossover bars to automatically adjust their height to enable the separator bars to match the contour of the roller griller rollers with substantially no gap therebetween.

A roller grill having a section divider ensemble is disclosed in U.S. Pat. Nos. 7,367,261 and 7,334,517. U.S. Pat. No. 7,367,261 provides a roller grill with a built-in fixed divider ensemble shaped to be positioned above the rollers for sectioning the rollers into two cooking areas. U.S. Pat. No. 7,334,517 further provides a roller grill with a section divider ensemble comprising front and back divider mounting braces, each having a series of slots or openings to accommodate divider bars. This arrangement makes it possible to vary the number and sizes of the cooking areas. In this divider ensemble device, use and vibrations can cause the spacing between the front and rear braces to become larger and then the dividers can fall onto the roller grill cooking surfaces. Additionally, the dividers disclosed in these prior art devices do not disclose a tooth-shaped configuration or support brackets with vertical members having curved slots to enable the separator bars to extend down and in between the rollers and follow the contour thereof.

As can be seen from the above, there is currently no device with separator bars with a tooth configuration that extend down and in between the rollers to follow the contour thereof.

### SUMMARY OF THE INVENTION

The present invention overcomes the problems inherent with currently existing roller grill dividers by providing a new and improved divider that prevents food from becoming lodged between or below the rollers. The device comprises a pair of support brackets, a pair of crossover bars, and a plurality of separator bars having a tooth-shaped configuration that extends down and in between the rollers to follow the contour thereof. The support brackets further comprise vertical members with curved slots for enabling the crossover bars to adjust their height. The adjustment of the crossover bars enables the separator bars to match the contour of the roller griller rollers with substantially no gap therebetween. The configuration of the separator bars and the curved slots creates a divider to separate food located on the roller grill surface, and to prevent food from becoming lodged between or below the rollers.

A method of using the roller grill separator to prevent corn dogs from being ejected from the roller grill surface is also disclosed. The configuration of the roller grill separator is particularly adapted to cooking corn dogs, as the divider prevents the corn dog sticks from becoming lodged between or below the rollers, which normally causes them to be ejected from the roller grill surface. The method comprises the steps of providing a roller grill separating device comprising a pair of support brackets, a pair of crossover bars attached at either end to the support brackets, and a plurality of separator bars comprising a tooth-shaped configuration; positioning the roller grill separating device on a roller grill; and positioning corn dogs between the separator bars on the roller grill; wherein the tooth-shaped configuration of the separator bars follows the contour of the roller grill rollers and extends down and in between the rollers such that the gap between the separator bars and the rollers is smaller than the width of the corn dog stick, thereby preventing the corn dog stick from lodging between the bars and the rollers and being ejected from the roller grill surface.

The present invention substantially diverges in design elements from the prior art and consequently it is clear that there is a need in the art for an improvement to existing roller grill separators. In this regard the instant invention substantially fulfills these needs.

### OBJECTS OF THE INVENTION

In view of the foregoing disadvantages inherent in the known types of roller grill dividers now present in the prior art, the present invention provides a new roller grill separating device wherein the same can be utilized for providing convenience to the user for separating various food products on the roller grill surface, and for preventing food, particularly corn dogs from becoming stuck between or below the roller surface.

It is therefore an object of the present invention to provide a new and improved roller grill separating device that has all of the advantages of the prior art and none of the disadvantages.

It is another object of the present invention to provide a roller grill separating device that can be used on an existing roller grill of any size, thus eliminating the need to purchase a brand-new roller grill with a divider ensemble.

Another object of the present invention is to provide a roller grill separating device that keeps grilled products in place and keeps uncooked products separated from cooked products on a grill so as to reduce food borne contamination and to maintain grill neatness at the same time.

Yet another object of the present invention is to provide a roller grill separating device that utilizes separator bars having a tooth-shaped configuration that extends down and between the rollers to follow the contour thereof.

Another object of the present invention is to provide a roller grill separating device having vertical members with curved slots for enabling the crossover bars to automatically adjust their height.

A final object of the present invention is to provide a roller grill separating device that prevents corn dog sticks from becoming stuck between the rollers, which normally causes them to be ejected from the roller grill surface

The roller grill separating device may be readily fabricated from materials that permit relative economy and are commensurate with durability. Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the roller grill separating device.

FIG. 2 shows a perspective view of a prior art roller grill separating device.

FIG. 3 shows an overhead view of the roller grill separating device.

FIG. 4 shows a side view of the roller grill separating device.

FIG. 5 shows a close-up view of the separator bars following the contours of the roller grill rollers.

FIG. 6 shows an exploded view of the roller grill separating device and a roller grill.

FIG. 7 shows a perspective view of the roller grill separating device installed on a roller grill.

FIG. 8. shows a perspective view of the roller grill separating device installed on a roller grill, with food in place on the rollers.

FIG. 9 shows a close-up view of the separator bars following the contours of the roller grill rollers, with food in place on the rollers.

### DETAILED DESCRIPTION OF THE INVENTION

Reference is made herein to the attached drawings. Like reference numerals are used throughout the drawings to depict like or similar elements of the roller grill separating device. For the purposes of presenting a brief and clear description of the present invention, the preferred embodiment will be discussed as used for separating food on a roller grill. The figures are intended for representative purposes only and should not be considered to be limiting in any respect.

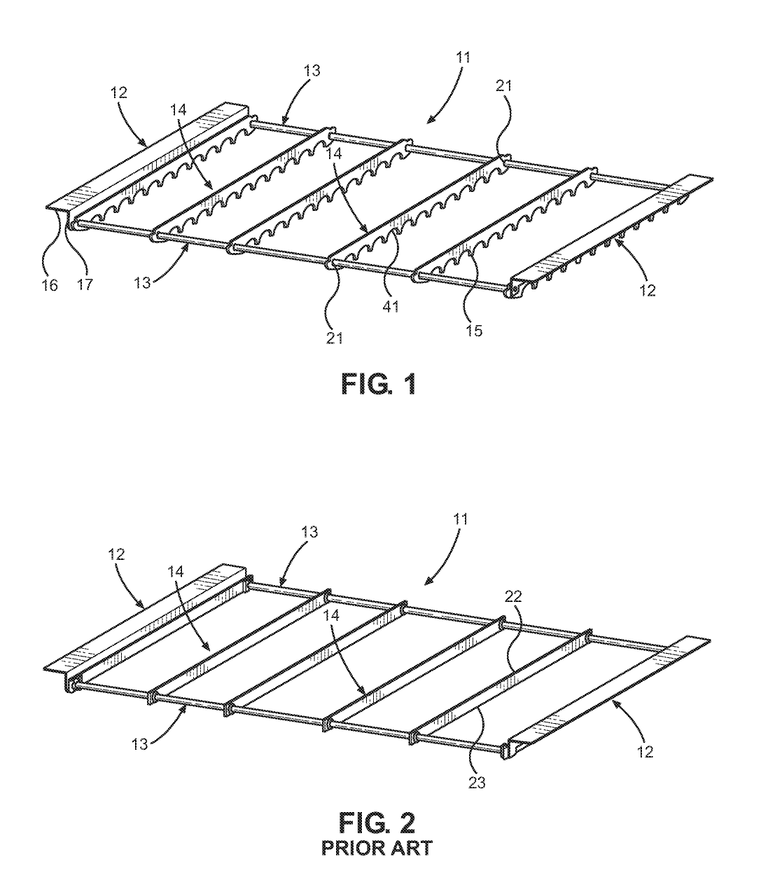

Referring now to FIG. 1, there is shown a perspective view of the roller grill separating device 11. The present invention comprises a pair of support brackets 12 for supporting the food separating device 11 on the housing of a roller grill, a pair of crossover bars 13 attached at either end to the support brackets 12, and a plurality of separator bars 14 comprising a tooth-shaped configuration 15 that follows the contour of the roller grill rollers and extends down and in between the rollers. The support brackets 12 and the crossover bars 13 form a rectangular configuration that enables the device 11 to fit on top of a conventional roller grill, which will be shown in greater detail below.

The separator bars 14 are disposed parallel to the support brackets 12 and are perpendicular to the crossover bars 13. Each support bracket 12 further comprises a horizontal section 16, and a vertical section 17. The separator bars 14 are attached at either end to the crossover bars 13 and are parallel to the support brackets 12.

Each separator bar 14 divides the surface of the roller grill into sections. As can be appreciated, the number and spacing of the separator bars 14 can vary based on user preference and depending on how many sections are desired. The separator bar 14 adjacent to the support bracket 12 can be omitted, thus it is possible to use the device 11 with one separator bar 14. Each crossover bar 13 extends through an aperture 21 in the separator bar 14. The aperture 21 can be round, U-shaped, square, or any other desired shape. A pair of O-rings disposed on either side of the aperture 21 of the separator bar 14 keeps the separator bar 14 from inadvertently sliding across the crossover bar 13. In a first alternate embodiment, a single, large O-ring can be used in place of a pair of O-rings, such that one O-ring loops around the aperture at each side of the separator bar 14. In a second alternate embodiment, the one or more O-rings can be replaced with a rubber grommet or any type of clip that would prevent the dividers from moving from the desired setting. As can be appreciated, the O-rings, grommets, or clips enable a user to adjust the position of the separator bars 14 and to lock them in position, wherein the O-rings, grommets, or clips prevent inadvertent movement caused by rotation and vibration of the roller grill.

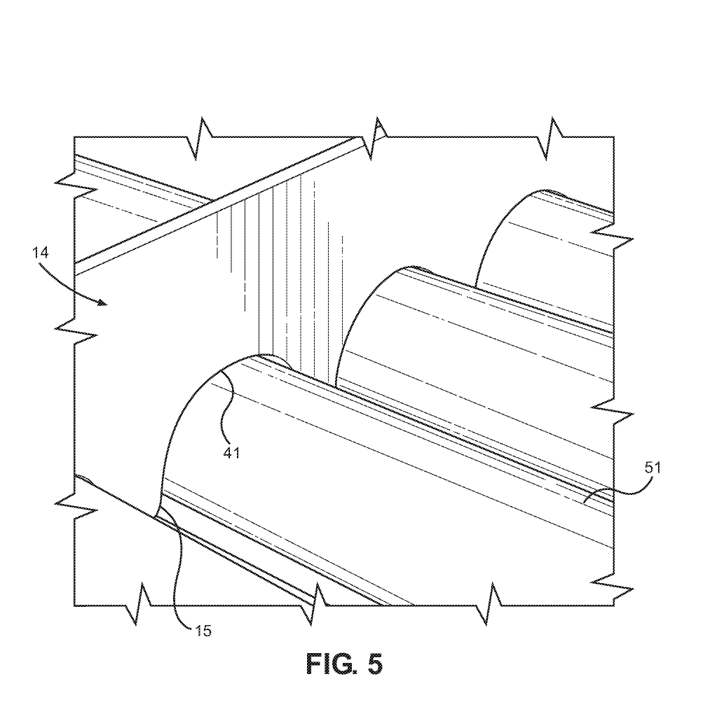

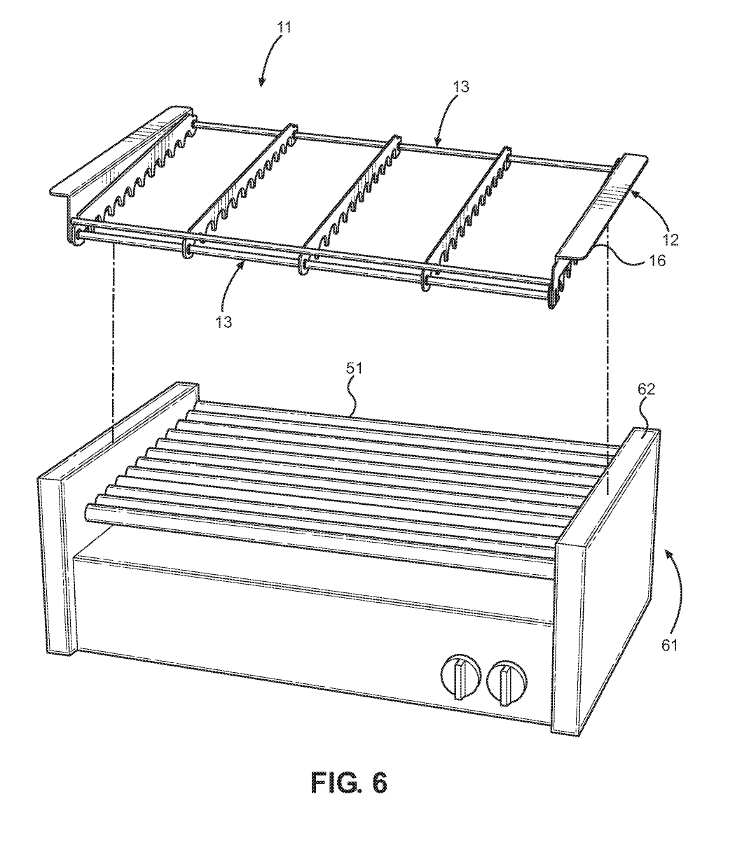

Referring now to FIG. 2, there is shown a perspective view of a prior art roller grill separating device 11. As shown, the prior art roller grill separating device 11 comprises a pair of support brackets 12 for supporting the food separating device 11 on the housing of a roller grill, a pair of crossover bars 13 attached at either end to the support brackets 12, and a plurality of separator bars 14. This prior art device, however, utilizes separator bars 14 with a flat upper 22 and a flat lower 23 surface. As shown in FIG. 1, the separator bars 14 of the present invention utilize a tooth-shaped configuration 15 that follows the contour of the roller grill rollers and extends down and in between the rollers. The prior art separator bars 14 are disposed above the surface of the roller grill rollers and do not extend down and in between the rollers. As can be appreciated, by remaining above the surface of the roller grill rollers, a gap or space exists between the separator bars 14 and the rollers. As best illustrated in FIG. 5, the present invention eliminates this gap with the addition of teeth 15. One of ordinary skill in the art would recognize that as food, such as hot dogs rotate on the rollers, they “walk” along the surface of the rollers, and from time to time become lodged between or below the separator bars 14 disclosed in the prior art. The present invention overcomes this problem by following the contours of the rollers such that the gap or space is virtually eliminated, thereby significantly reducing the possibility of food becoming lodged between or below the rollers or separator bars 14.

A second advantage of the roller grill separating device 11 of the present invention, as best illustrated in FIG. 1, are the first slot 19 and the second slot 20 that enable height adjustment of the device 11 when positioned on a roller grill. The slots 19, 20 enable the device 11 to automatically adjust its height such that the separator bars 14 match the contour of the roller griller rollers with substantially no gap therebetween. The separator bars 14 of the prior art device 11, as best illustrated in FIG. 2, lack a means for height adjustment, which may increase the size of the gap or space between the separator bars 14 and the rollers. This in turn increases the opportunity for food to become lodged between or below the rollers or separator bar 14.

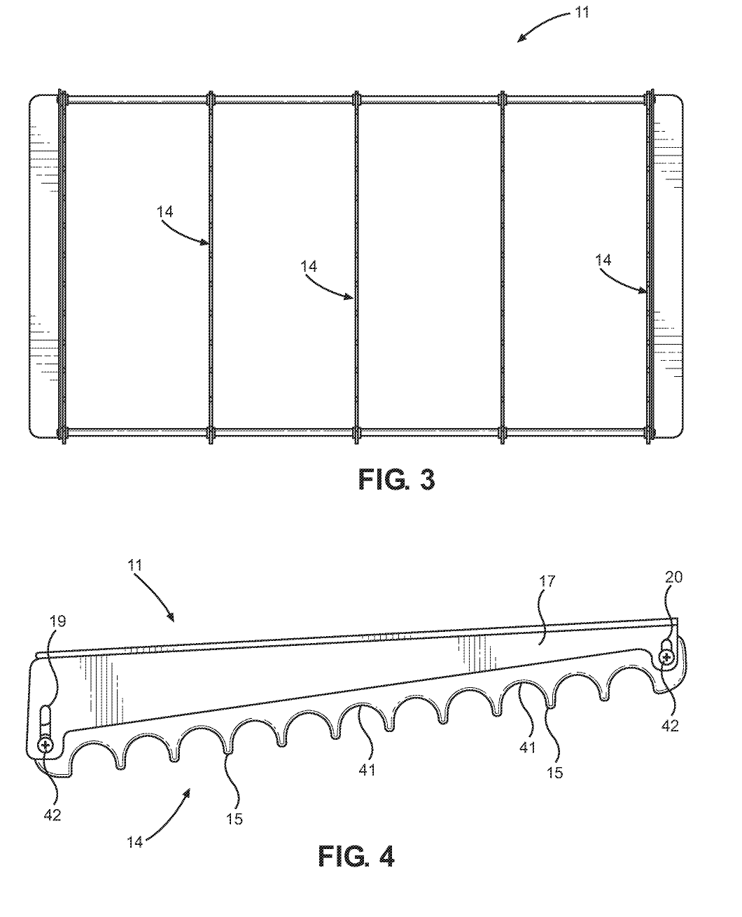

Referring now to FIG. 3, there is shown an overhead view of the roller grill separating device 11. The roller grill separating device 11 is designed to be placed on top of a conventional roller grill that is well known in the art. The device 11 is preferably manufactured as a one-piece component, which prevents the need for assembly by end users, decreases the chance for lost or misplaced parts, and simplifies cleaning. As shown, the separator bars 14 are equidistant. However, the spacing of the bars 14 can be adjusted to suit end user needs. A user can adjust the spacing based on the number or type of food product being cooked with the roller grill. Once adjusted, the O-rings, grommets, or clips prevent inadvertent movement of the separator bars 14, which is typically caused by rotation and/or vibration of the roller grill.

Referring now to FIG. 4, there is shown a side view of the roller grill separating device 11. The separator bars 14 include a tooth-shaped configuration 15 that follows the contour of the roller grill rollers and extends down and in between the rollers. The space from a first tooth to a second tooth 15 forms a semi-circle 41 that matches the size and shape of the rollers on the roller grill. As best shown in FIG. 5, the semi-circle 41 configuration enables the separator bars 14 to extend down and between the rollers 51 to substantially close the gap between the separator bars 14 and the rollers 51.

As shown in FIG. 4, each support bracket 12 further comprises a horizontal section 16, and a vertical section 17. The vertical section 17, includes a first slot 19 and a second slot 20 that enables height adjustment of the device 11 when positioned on a roller grill. The crossover bars (not shown) are attached to the support bracket 12 at each slot 19, 20 via a fastener, such as a screw 42. The screw 42 can be tightened or loosened as desired. As can be appreciated, if the screws 42 are left loose, the crossover bars will move freely within the slots 19, 20. This is ideal for positioning the device 11 on the roller grill surface such that the separator bars 14 do not make direct contact with the rollers. If the bars 14 contact the rollers, the rollers may be scratched or damaged. This is prevented by adjusting the height such that the bars do not touch the rollers but are so close to the rollers as to prevent food from becoming lodged between or below.

Referring now to FIG. 5, there is shown a close-up view of the separator bars following the contours of the roller grill rollers 51. As can be appreciated by one of ordinary skill in the art, as hotdogs and similar types of food are cooking or warming on a roller grill, they rotate with the rollers 51. The rotation can cause the food to “walk” along the surface of the rollers 51. When food walks along the surface of the rollers 51 and eventually makes contact with conventional crossover bars that do not extend down and between the rollers 51, the food acts as a screw. The screw motion causes food to rotate down and between the rollers 51 and the separator bars 14 until it becomes lodged in between and/or broken apart. This in turn, causes waste, as food that is broken apart on the roller grill is unappetizing and cannot be sold to consumers. By extending down and below the surface of the rollers 51, the separator bars 14 of the present invention prevent the food from rotating down and between the rollers 51 and being broken apart.

Referring now to FIG. 6, there is shown an exploded view of the roller grill separating device 11 and a roller grill 61. The roller grill separating device 11 is designed to rest on the rollers 51 of a conventional roller grill 61. As can be appreciated, the device 11 is sized to fit on top of a conventional grill 61. The horizontal section 16 of the support bracket 12 is designed to rest on the sidewall 62 of the grill 61. The horizontal section 16 matches the length and width of the sidewall 62 to provide a secure fit therebetween. The crossover bars 13 span the length of the rollers 51 between the sidewalls 62. The device 11 can be installed by simply aligning the horizontal sections 16 between the sidewalls 62 and resting the horizontal sections 16 directly on top of the sidewalls 62. When use of the roller grill separating device 11 is not desired or if cleaning is required, the device 11 can be removed for storage or for cleaning.

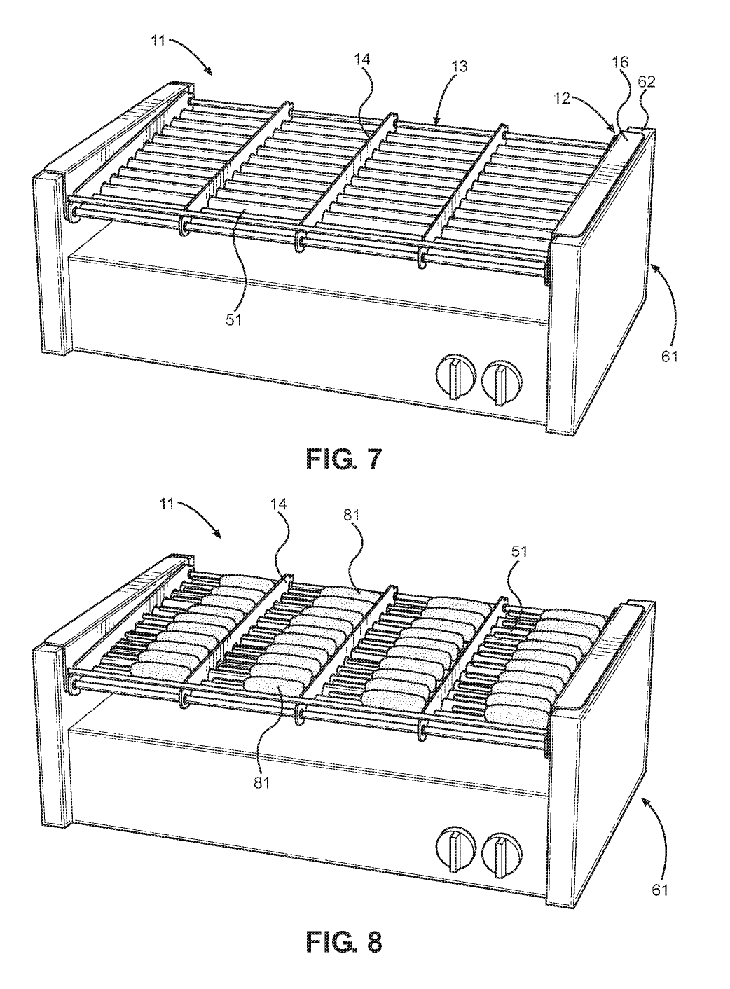

Referring now to FIG. 7, there is shown a perspective view of the roller grill separating device 11 installed on a roller grill 61. As described above, the roller grill separating device 11 can be installed by simply aligning the horizontal sections 16 between the sidewalls 62 and resting the horizontal sections 16 directly thereon. As shown, the separator bars 14 follow the contour of the roller grill rollers 51 and extend down and in between the rollers 51. The separator bars 14 form a semi-circle configuration that matches the size and shape of the rollers 51 on the roller grill 61. The configuration of the separator bars 14 enable them to substantially close the gap between the separator bars 14 and the rollers 51.

The support brackets 12 are designed to provide height adjustment for the crossover bars 13 and the separator bars 14. As shown, the rollers 51 on the roller grill 61 are angled down and towards the front of the device 11, which affords ease of access to employees or customers when adding or removing food from the grill 61. The separator bars 14 match the angle of the rollers 51 on the grill 61, while being positioned in such a manner as to prevent the bars 14 from making direct contact with and scratching the rollers 51. As can be appreciated, the gap between the rollers 51 and the bars 14 is small enough to prevent food from becoming lodged between or below the rollers.

Referring now to FIG. 8, there is shown a perspective view of the roller grill separating device 11 installed on a roller grill 61, with food 81 in place on the rollers. The separator bars 14 divide the surface of the roller grill 61 into sections. As can be appreciated, the number and spacing of the separator bars 14 can vary based on user preference and depending on how many sections are desired. The bars 14 can be positioned as desired based on the size, quantity, or type of food to be cooked on the roller grill 61. In a first non-limiting example, a user can divide the roller grill 61 into a cooking section and a warming section. In a second non-limiting example, a user can divide the roller grill 61 into multiple sections to cook different types of food, including hot dogs, spicy sausage, mild sausage, and the like. In a third non-limiting embodiment, the separator bars 14 can be used to prevent food, such as corn dogs 81, from walking along the surface of the rollers 51 and becoming lodged between or under the separator bars 14. In this embodiment, the bars 14 function to separate the grill 61 into different sections and to prevent food from becoming stuck between rollers 51.

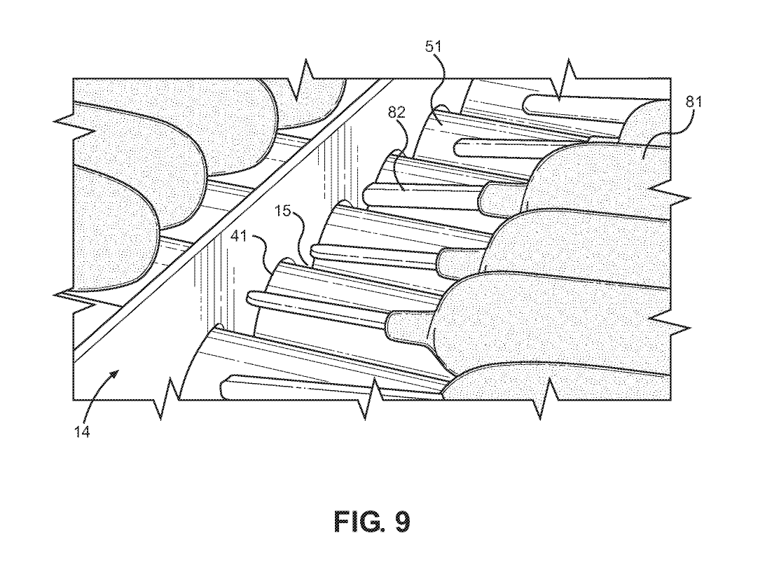

Referring now to FIG. 9, there is shown a close-up view of the separator bars 14 following the contours of the roller grill rollers 51, with food 81 in place on the rollers 51. In this embodiment, the present invention will be discussed with cooking corn dogs 81. As is well known in the art, corn dogs 81 are not commonly cooked or warmed on a roller grill, as their configuration makes them prohibitively difficult to use with this type of device. Corn dogs 81 comprise a stick 82 that extends from one side thereof, which provides a consumer a location to grasp onto and eat the product. The difficulty with cooking/warming corn dogs 81 on a roller grill is that the sticks 82 become lodged between or below the roller grill rollers 51 as the corn dog 81 rotates. As the sticks 82 become lodged further between the rollers 51, the corn dogs 81 are eventually ejected from the rollers 51. Once the corn dog 81 is inadvertently removed from the rollers 51, it is no longer sanitary and must be discarded, which increases waste and decreases revenue for establishments.

As shown, the separator bars 14 substantially close the gap between the bars 14 and the rollers 51. In the preferred embodiment, the gap between the bars 14 and the rollers 51 is smaller than the width of the stick 82, making it virtually impossible for the stick 82 to lodge between or below the bars 14 and rollers 51. If the corn dog 81 begins to “walk” along the rollers 51, it will make contact with the separator bar 14, which will serve as a wall to prevent further movement. As described above and best illustrated in FIGS. 4 and 5, the distal end of the bars 14 include a tooth-shaped configuration 15 that follows the contour of the roller grill rollers 51 and extends down and in between the rollers 51. The depth of the teeth 15 is such that the stick 82 is prevented from lodging therebelow, thereby preventing ejection of the corn dog 81 from the rollers 51.

In addition to the roller grill separating device, a method of preventing corn dogs from being ejected from a roller grill is also disclosed. The method comprises the steps of providing a roller grill separating device comprising a pair of support brackets, a pair of crossover bars attached at either end to the support brackets, and a plurality of separator bars comprising a tooth-shaped configuration; positioning the roller grill separating device on a roller grill; and positioning corn dogs between the separator bars on the roller grill; wherein the tooth-shaped configuration of the separator bars follows the contours of the roller grill rollers and extends down and between the rollers such that the gap between the separator bars and the rollers is smaller than the width of the corn dog stick, thereby preventing the corn dog stick from lodging between the bars and the rollers and being ejected from the roller grill surface.

As discussed above, any suitable materials, such as plastic and metal can be used to manufacture the present invention, and methods of manufacturing are not particularly limited. Preferably, the roller grill separating device is manufactured as a one-piece component, which prevents the need for assembly by end users, decreases the chance for lost or misplaced parts, and simplifies cleaning.

Overall, the present invention provides a convenient solution for separating food and preventing food from being damaged or ejected from a roller grill. The separator bars follow the contours of the grill rollers, which prevents food from becoming stuck between or below the rollers. Most advantageously, the present invention provides a means for cooking and warming corn dogs with a conventional roller grill. The device can be quickly installed and removed for storage or cleaning.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A food separating device for use with a roller grill, said roller grill comprising a housing and rollers, said food separating device comprising:
a pair of support brackets for supporting said food separating device on said housing of said roller grill;
a pair of crossover bars attached at either end to said support brackets, wherein said support brackets and said crossover bars form a rectangular configuration;
a plurality of separator bars comprising a tooth-shaped configuration, wherein said tooth-shaped configuration follows the contour of said roller grill rollers and extends down and in between said rollers while not making contact with said roller grill rollers, wherein said separator bars are attached at either end to said crossover bars and are parallel to said support brackets;
said support brackets further comprising a pair of horizontal members and two pairs of vertical members, said vertical members each comprising a slot for securing said crossover bars and enabling said crossover bars to adjust their height such that said separator bars do not make direct contact with said roller grill rollers.

2) The device of claim 1, wherein said separator bars create a divider that prevents food from lodging between said rollers.

3) The device of claim 1, wherein said crossover bars extend through an aperture in each of said separator bars.

4) (canceled)

5) The device of claim 1, wherein said crossover bars are attached to said support bracket at each slot via a fastener.

6) The device of claim 1, wherein said food separating device is manufactured as a unitary device with permanently joined members.

7) (canceled)

8) A food separating device for use with a roller grill, said roller grill comprising a housing and rollers, said food separating device comprising:
a pair of support brackets for supporting said food separating device on said housing of said roller grill;
a pair of crossover bars attached at either end to said support brackets, wherein said support brackets and said crossover bars form a rectangular configuration;
a plurality of separator bars comprising a tooth-shaped configuration, wherein said tooth-shaped configuration follows the contour of said roller grill rollers and extends down and in between said rollers while not making contact with said roller grill rollers, wherein said separator bars are attached at either end to said crossover bars and are parallel to said support brackets wherein said separator bars prevent corndog sticks from getting stuck between said rollers;
said support brackets further comprising a pair of horizontal members and two pairs of vertical members, said vertical members each comprising a slot for securing said crossover bars and enabling said crossover bars to adjust their height
wherein said crossover bars are attached to said support bracket at each of said slots via a screw, wherein said screws can be tightened to loosened to adjust the height of said separator bars such that said bars do not make contact with said roller grill rollers.

9) The device of claim 8, wherein said separator bars create a divider that prevents food from lodging between said rollers.

10) The device of claim 8, wherein said crossover bars extend through an aperture in said separator bar.

11) (canceled)

12) The device of claim 8, wherein said crossover bars are attached to said support bracket at each slot via a fastener.

13) The device of claim 8, wherein said food separating device is manufactured as a one-piece component.

14) (canceled)

15) A method for preventing corn dogs from being ejected from a roller grill, comprising:
providing a roller grill separating device comprising a pair of support brackets, a pair of crossover bars attached at either end to said support brackets, and a plurality of separator bars comprising a tooth-shaped configuration;
positioning said roller grill separating device on said roller grill; and
positioning said corn dogs between said separator bars on said roller grill;
wherein said tooth-shaped configuration of said separator bars follows the contour of said roller grill rollers and extends down and in between said rollers while not making contact with said roller grill rollers, wherein said separator bars are attached at either end to said crossover bars and are parallel to said support brackets, wherein said separator bars prevent corndog sticks from getting stuck between said rollers.
